(19) United States
(12) Patent Application Publication
(10) Pub. No.: US 2016/0283285 A1
(43) Pub. Date: Sep. 29, 2016

(54) SYNCHRONIZING CONTROL AND OUTPUT OF COMPUTING TASKS

(71) Applicant: International Business Machines Corporation, Armonk, NY (US)

(72) Inventors: Venkatuday M. Balabhadrapatruni, San Jose, CA (US); Melvin E. Fowler, II, San Jose, CA (US); Michael S. Fulton, Squamish (CA); Gary I. Mazo, San Jose, CA (US); Brian W. Svihovec, Cary, NC (US)

(21) Appl. No.: 14/665,379

(22) Filed: Mar. 23, 2015

(51) Int. Cl. G06F 9/52

(52) U.S. Cl. CPC G06F 9/52

(57) ABSTRACT

According to one embodiment of the present invention, a system for tracking control for computing tasks receives a reference to a control file specifying a computing task. The system submits the specified task for performance on a computing system in accordance with the control file and receives an identifier for the performance of the task. The system stores information associating the identifier and the reference, and, in response to receiving a request for information associated with the identifier, returns the associated reference. Embodiments of the present invention further include a method and computer program product for maintaining metadata for computing tasks in substantially the same manners described above.

### BACKGROUND

Present invention embodiments pertain to tracking control of computing tasks, and more specifically, to maintaining relations between executed jobs and control files that specify individual jobs and corresponding parameters.

In processing systems, a task or set of tasks (sometimes referred to as a “job”) may be specified by a source file containing instructions expressed in a scripting language. For example, a job is submitted to the Job Entry Subsystem (JES) component of the z/OS operating system using a source file containing instructions written in Job Control Language (JCL). JES carries out the instructions and copies the instructions from the source file into a file stored with the job output. However, the identity and location of the original source file are not saved.

### SUMMARY

According to one embodiment of the present invention, a system for tracking control for computing tasks receives a reference to a control file specifying a computing task. The system submits the specified task for performance on a computing system in accordance with the control file and receives an identifier for the performance of the task. The system stores information associating the identifier and the reference, and, in response to receiving a request for information associated with the identifier, returns the associated reference. Embodiments of the present invention further include a method and computer program product for maintaining metadata for computing tasks in substantially the same manners described above.

### BRIEF DESCRIPTION OF THE SEVERAL VIEWS OF THE DRAWINGS

Generally, like reference numerals in the various figures are utilized to designate like components.

FIG. 1 is a diagrammatic illustration of an example environment for an embodiment of the present invention.

FIG. 2 is a flow diagram illustrating an example manner of associating a control file specifying a job with a job output according to an embodiment of the present invention.

FIG. 3 depicts an example instance of metadata for associating control files to job identifiers according to an embodiment of the present invention.

FIG. 4 is an illustration of an example display of job metadata according to an embodiment of the present invention.

FIG. 5 is an illustration of an example reference to a job's control file with an indication that the control file has been modified after the job's results were produced.

### DETAILED DESCRIPTION

Present invention embodiments track computing tasks (e.g., producing files, datasets, etc.) and controls used to perform them (e.g., hatch scripts, programs, processes, etc.). In addition, present invention embodiments may provide manners of visualizing the relationships. For example, the output of a job may be linked back to a control file (or script) used to specify the job, and a display of information about the job may indicate whether the originating control file has been modified after the output was produced. Conventional processing systems such as mainframe systems using JES do not preserve the relationship between the originating control file and the results of a job run. Accordingly, present invention embodiments provide a manner of enhancing such processing systems and development tools for such systems by maintaining relations between executed jobs and control files that specify individual jobs and corresponding parameters.

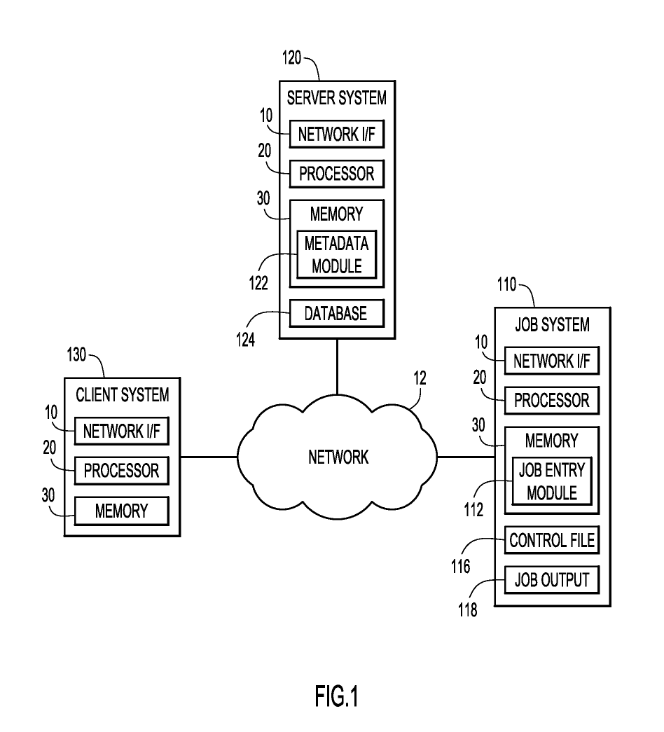

An example environment for present invention embodiments is illustrated in FIG. 1. Specifically, the environment includes one or more job systems 110, one or more server systems 120, and one or more client or end-user systems 130. Job systems 110, server systems 120, and client systems 130 may be remote from each other and communicate over a network 12. Network 12 may be implemented by any number of any suitable communications media (e.g., wide area network (WAN), local area network (LAN), Internet, intranet, etc.). Alternatively, any number of job systems 110, server systems 120, and/or client systems 130 may be local to each other, and communicate via any appropriate local communication medium (e.g., local area network (LAN), hardwire, wireless link, intranet, etc.).

Job system 110 preferably provides a main frame type of environment and includes job entry module 112 (e.g., JES) to receive requests to run jobs specified by corresponding control files 116 (e.g., JCL files). The job entry module may execute submitted jobs, producing a corresponding job output 118 (e.g., output files, results, etc.) for each executed job.

Server system 120 includes metadata module 122 and database 124 to store metadata for associating job outputs 118 with the corresponding control files 116 used to produce those outputs. Metadata module 122 may be implemented as part of a web application server.

Client systems 130 enable users to communicate (e.g., via network 12) with server system 120 and/or job system 110 to submit jobs and request metadata linking a job with the control file used to specify the job. The client systems may include a web browser or present any graphical user (e.g., GUI, etc.) or other interface (e.g., command line prompts, menu screens, etc.) to receive commands from users, display information, and interact with the metadata module and/or other modules or systems.

Job system 110, server system 120, and client system 130 may be implemented by any conventional or other computer systems preferably equipped with a display or monitor, a base (e.g., including at least one processor 20, memories 30 and/or internal or external network interface or communications devices 10 (e.g., modem, network cards, etc.)), optional input devices (e.g., a keyboard, mouse, or other input device), and any commercially available and custom software (e.g., web server software, web browser software, database software, job control software, applications, etc.)).

The client system, server system, and/or job system may include one or more modules or units (e.g., web browser, metadata module 122, job entry module 112, database management system, etc.) to perform the various functions of present invention embodiments described below (e.g., editing control files, submitting jobs, viewing job metadata, maintaining job metadata, managing jobs, etc.), which may be implemented by any combination of any quantity of software and/or hardware modules or units, and may reside within memory 30 of a job system, server system, and/or client systems for execution by processor 20.

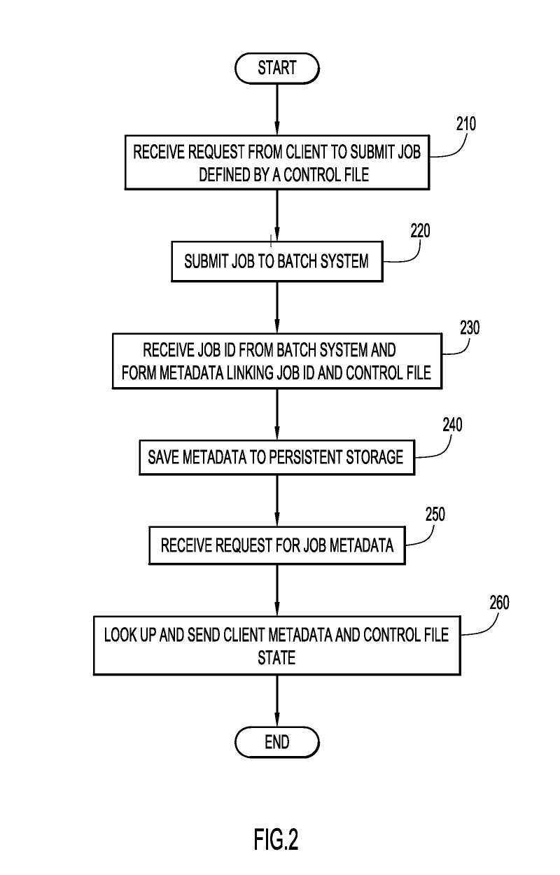

An example manner of associating a control file specifying a job with the job's output according to an embodiment of the present invention is illustrated in FIG. 2. Initially, a user may create, modify, view or otherwise access a control file 116 that specifies a job to be submitted to job system 110. The user may submit the job by sending a request (e.g., via network 12) from client 130 to metadata module 122 of server system 120. The request indicates the job system 110 to which the job is to be submitted and includes a reference (e.g., a URL, filename, etc.) to the control file 116 that specifies the instructions to he performed for the job (e.g., commands and/or applications to be run, input data, where to store output of the job, etc.). In one embodiment, the client sends the request using the Hypertext Transfer Protocol (HTTP) PUT method. The metadata module receives the request at step 210.

At step 220, the metadata module submits the job to job entry module 112 of the job system 110 indicated in the request. The metadata module may submit the job by sending the job entry module a reference to the control file. Alternatively, the metadata module may access the control file and submit the request by sending the contents of the control file to the job entry module. In response to receiving the job submission, the job entry module queues the job to run, generates an identifier for the job (e.g., JOB01606), and returns the job identifier to the metadata module.

At step 230, the metadata module receives the job identifier generated by the job entry module and forms metadata for the job, including the job identifier and the reference to the control file. The metadata module sends the job identifier to the client system. The client system may send the metadata module a request containing the job identifier (e.g., once the job has completed). In response, the metadata module sends the metadata for the job to the client.

At step 240, the metadata module may save the metadata to persistent storage (e.g., in database 124). The metadata module may store job metadata automatically after receiving the job identifier from the job entry module. Alternatively, the metadata module may store metadata in response to a request from the client (e.g., using the HTTP PUT method).

At step 250, the metadata module receives a request from the client for job metadata saved to persistent storage. For example, a user may access job output 118 for a previously completed job, read the identifier of the job stored in that output, and send a request to the metadata module for the metadata associated with that job identifier (e.g., using the HTTP GET method).

In response to the request, the metadata module reads the metadata for the job from the persistent storage and sends the metadata to the client at step 260. The metadata includes the control file reference in order to retrieve the control file used for the job. The client may display the metadata to the user (e.g., in a web browser).

In addition, when the metadata module receives a request for job metadata, the metadata module may analyze the metadata to determine whether the control file for the job is consistent with the metadata and/or job output. For example, the metadata module may determine whether the control file has been modified since the job was submitted. An indication of the whether the control file is consistent may be included in the results returned to the client for display.

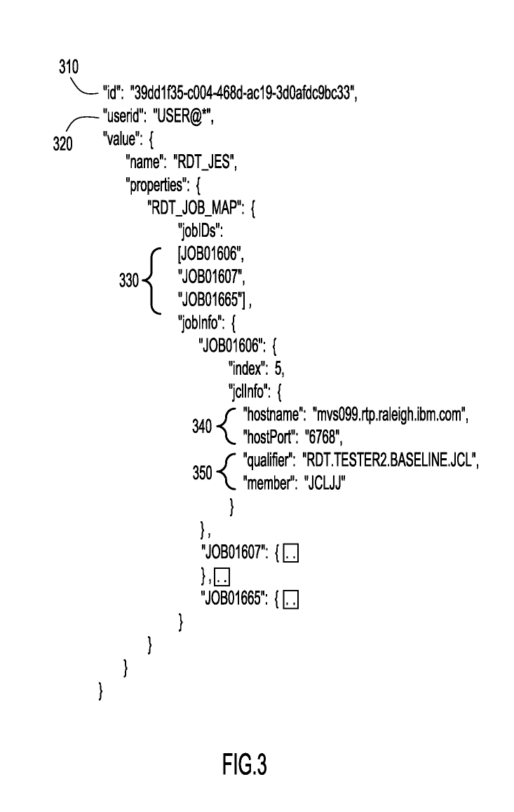

An example instance of metadata for associating control files to job identifiers according to an embodiment of the present invention is illustrated in FIG. 3. In particular, a metadata record may include an identifier of the record 310, a user identifier 320, a list of job identifiers 330 (e.g., identifiers of jobs submitted by a user during a session), and, for each job, an identifier of the job system 340 and a reference to the job control file 350. In addition, the metadata for each job may include a token for the control file used to submit the job (e.g., a checksum, timestamp, etc.). Consistency of the control file with the job metadata or output may be determined by comparing the token stored in the metadata with a corresponding token for the control file at a later time.

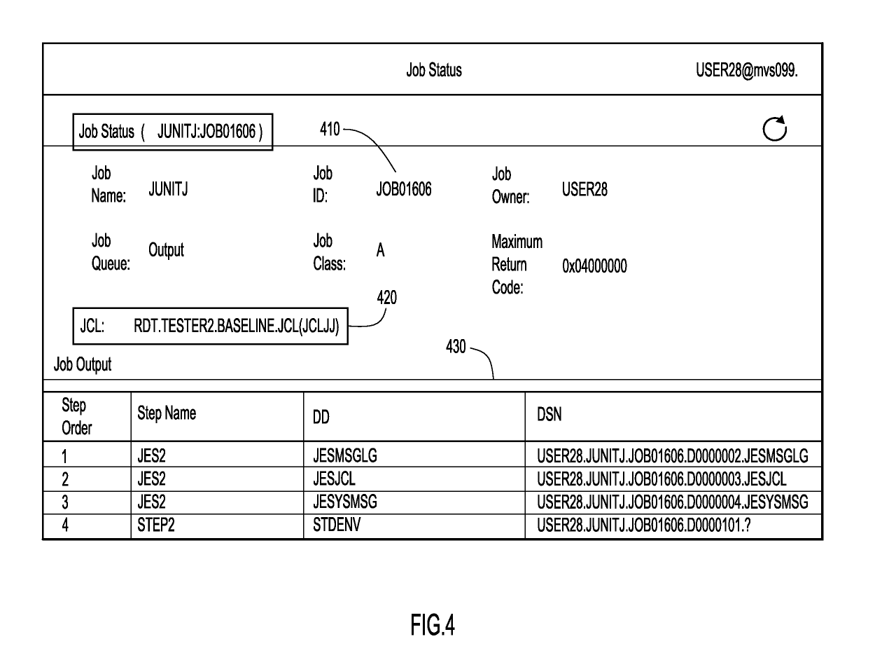

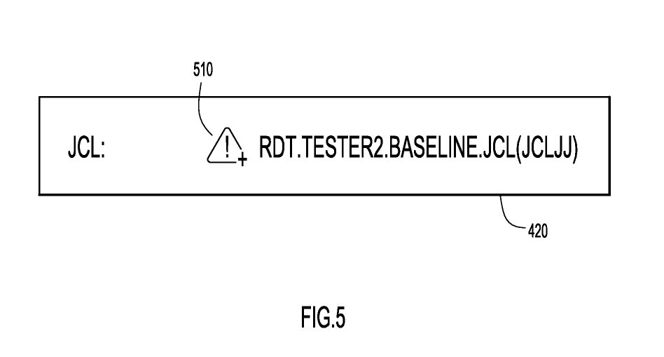

An example display of job metadata according to an embodiment of the present invention is illustrated in FIG. 4. In particular, the display includes a job identifier 410, a reference 420 to the job control file used to submit the job, and a job output table 430. An example reference 420 to a job's control file with an indication 510 that the control file has been modified after the job's results were produced is illustrated in FIG. 5.

It will be appreciated that the embodiments described above and illustrated in the drawings represent only a few of the many ways of implementing embodiments for synchronizing control and output of computing tasks.

The environment of the present invention embodiments may include any number of computer or other processing systems (e.g., client or end-user systems, server systems, main frames, etc.) and storage systems (e.g., file systems, databases, or other repositories), arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., database software, communications software, etc.). These systems may include any types of monitors and input devices (e.g., keyboard, mouse, voice recognition, touch screen, etc.) to enter and/or view information.

It is to be understood that the software of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.), The interface screens may include any suitable actuators (e.g., links, tabs, etc.) to navigate between the screens in any fashion.

The present invention embodiments are not limited to the specific tasks or algorithms described above, but may be utilized for preserving the relationship between data artifacts of any type (e.g., files, datasets, etc.) and any sources used to produce them (e.g., batch scripts or other job control files, programs, processes, etc.). A job control file may be expressed in any language or combination of language (e.g., JCL, bash, etc.). Job control files and job output may reside together or apart on at any location (e.g., job system 110, server system 120, client system 130, or other local or remote system). The job entry module may be implemented using any conventional or other queue system, job scheduler, shell, or the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). in some embodiments, electronic circuitry including, for example, programmable logic circuitry, field.-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-8. (canceled)

9. A system for tracking control for computing tasks comprising:
at least one processor configured to:
receive a reference to a control file specifying a computing task;
submit the specified task for performance on a computing system in accordance with the control file and receive an identifier for the performance of the task;
store information associating the identifier and the reference;
receive a request for information associated with the identifier and in response return the associated reference.

10. The system of claim 9, wherein the performance of the task comprises storing output of the task and the output comprises the identifier.

11. The system of claim 9, wherein the at least one processor is further configured to:
determine that the control file has been modified since the submitting of the specified task.

12. The system of claim 11, wherein returning the associated reference comprises returning an indication that the control file has been modified since the submitting of the specified task.

13. The system of claim 9, wherein submitting the computing system for performing the specified task comprises a mainframe computing system.

14. The system of claim 13, wherein the control file is a Job Control Language (JCL) file.

15. A computer program product for tracking control for computing tasks comprising:
a computer readable storage medium having computer readable program code embodied therewith for execration on a processing system, the computer readable program code comprising computer readable program code configured to:
receive a reference to a control file specifying a computing task;
submit the specified task for performance on a computing system in accordance with the control file and receive an identifier for the performance of the task;
store information associating the identifier and the reference;
receive a request for information associated with the identifier and in response return the associated reference.

16. The computer program product of claim 15, wherein the performance of the task comprises storing output of the task and the output comprises the identifier.

17. The computer program product of claim 15, wherein the at least one processor is further configured to:
determine that the control file has been modified since the submitting of the specified task.

18. The computer program product of claim 17, wherein returning the associated reference comprises returning an indication that the control file has been modified since the submitting of the specified task.

19. The computer program product of claim 15, wherein submitting the computing system for performing the specified task comprises a mainframe computing system.

20. The computer program product of claim 19, wherein the control file is a Job Control Language (JCL) file.
